(19) United States
(12) Patent Application Publication
(10) Pub. No.: US 2019/0168773 A1
(43) Pub. Date: Jun. 6, 2019

(54) TRAILER HAULING LOAD LIMIT PROTECTION SYSTEM

(71) Applicant: Toyota Motor Engineering & Manufacturing North America, Inc., Erlanger, KY (US)

(72) Inventors: Ahmad Hamdoun, Dearborn, MI (US); Kevin L. Cox, Monroe, MI (US); Lloyd Dunlap, Brighton, MI (US)

(21) Appl. No.: 15/829,105

(22) Filed: Dec. 1, 2017

(51) Int. Cl. B60W 50/12; B60W 40/13; B60W 30/188

(52) U.S. Cl. CPC B60W 50/12; B60W 40/13; B60W 2520/105; B60W 2530/22; B60W 30/188

(57) ABSTRACT

A trailer load limit protection system limits operation of a vehicle when towing a trailer having a weight that exceeds a maximum allowable weight limit for the vehicle. The protection system limits operation of the vehicle when it determines an actual acceleration of the vehicle when towing the trailer is less than a predicted vehicle acceleration for the vehicle when towing a trailer having a weight equal to a maximum allowable trailer weight for the vehicle. Vehicle operation is also limited when it is determined that an actual transmission shift point is occurring before a predicted transmission shift point for the vehicle when towing a trailer having a weight equal to a maximum allowable trailer weight for the vehicle. Vehicle operation is limited by controlling a maximum allowable speed of the vehicle or preventing the transmission on the vehicle from being shifted from a park position to a drive position.

### BACKGROUND

A vehicle may be configured to tow a trailer. The maximum weight a vehicle may tow is a function of the design and configuration of the vehicle. If the vehicle has a trailer hitch and is towing a trailer, there is a maximum overall weight of the vehicle and trailer combination, composed of an overall weight of the vehicle and a weight of the trailer, that should not be exceeded. Although the maximum values for the vehicle and trailer weights are typically recorded in the vehicle's user manual, or otherwise made available to the vehicle operator, in practice, many users may not be aware of the significance of these parameters, and if they are, may not pay attention to them when loading their vehicle and/or trailer. It may therefore be the case that the permitted maximum weight values are exceeded and a vehicle and/or trailer is overloaded. As a result, the dynamics of the vehicle and/or trailer that is overloaded may be degraded and/or the structural integrity of the vehicle compromised.

### SUMMARY

Disclosed is a trailer load limit protection system that limits operation of a vehicle when towing a trailer having a weight that exceeds a maximum allowable weight limit for the vehicle. The trailer load limit protection system limits operation of the vehicle when the protection system determines that an actual acceleration of the vehicle when towing the trailer is less than a predicted vehicle acceleration for the vehicle when towing a trailer having a weight equal to a maximum allowable trailer weight for the vehicle. Vehicle operation may also be limited when the trailer load protection system determines that an actual transmission shift point of a transmission on the vehicle is occurring before a predicted transmission shift point for the transmission when towing a trailer having a weight equal to a maximum allowable trailer weight for the vehicle. Vehicle operation may be limited by controlling a maximum allowable speed of the vehicle or preventing the transmission on the vehicle from being shifted from a park position to a drive position.

### BRIEF DESCRIPTION OF THE DRAWINGS

The various features, advantages and other uses of the present apparatus will become more apparent by referring to the following detailed description and drawings, in which:

FIG. 1 is a schematic illustration of a vehicle towing a trailer;

FIG. 2 is a schematic illustration of the vehicle employing a trailer load limit protection system; and

FIG. 3 is a schematic illustration of the trailer load limit protection system.

### DETAILED DESCRIPTION

A trailer load limit protection system is disclosed. The trailer load limit protection system is configured to avoid damage to a vehicle and minimize disruption of vehicle dynamics that may occur when towing a trailer that exceeds a maximum allowable weight for the vehicle. The vehicle may employ sensors for monitoring operating parameters of the vehicle, such as, for example, vehicle speed, accelerator pedal position and fuel flow rates. Data collected from the various sensors may be used to determine a weight of the trailer being towed. If the determined trailer weight exceeds a maximum allowable trailer weight for the vehicle a control module within the vehicle may initiate one or more protective measures designed to avoid damage to the vehicle and minimize degradation of vehicle dynamics that may occur when towing a trailer that exceeds the maximum allowable weight limit for the vehicle. The protective measures may include limiting a maximum speed of the vehicle and locking a transmission shift mechanism in a park position to prevent the vehicle from being driven.

Referring now to the discussion that follows and the drawings, illustrative approaches to the disclosed systems and methods are described in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

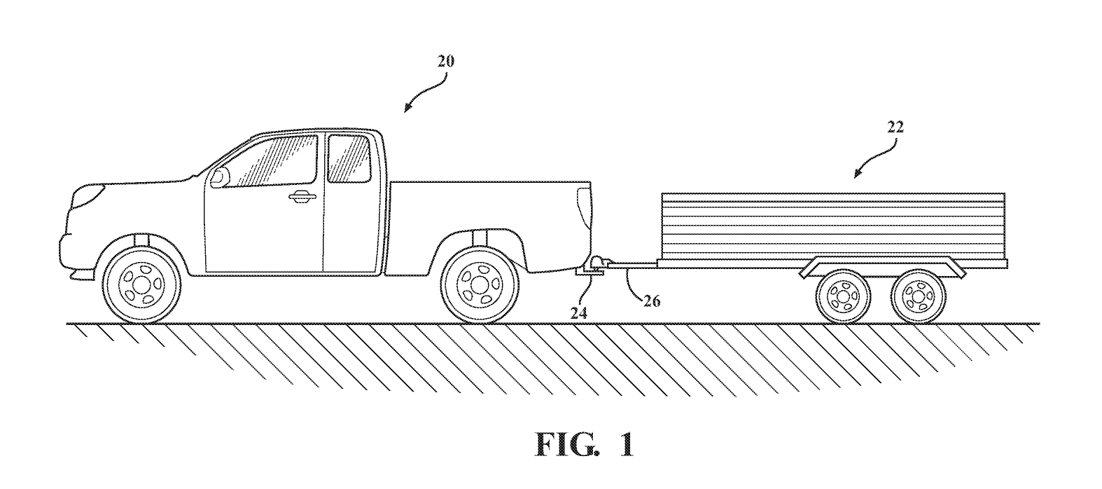

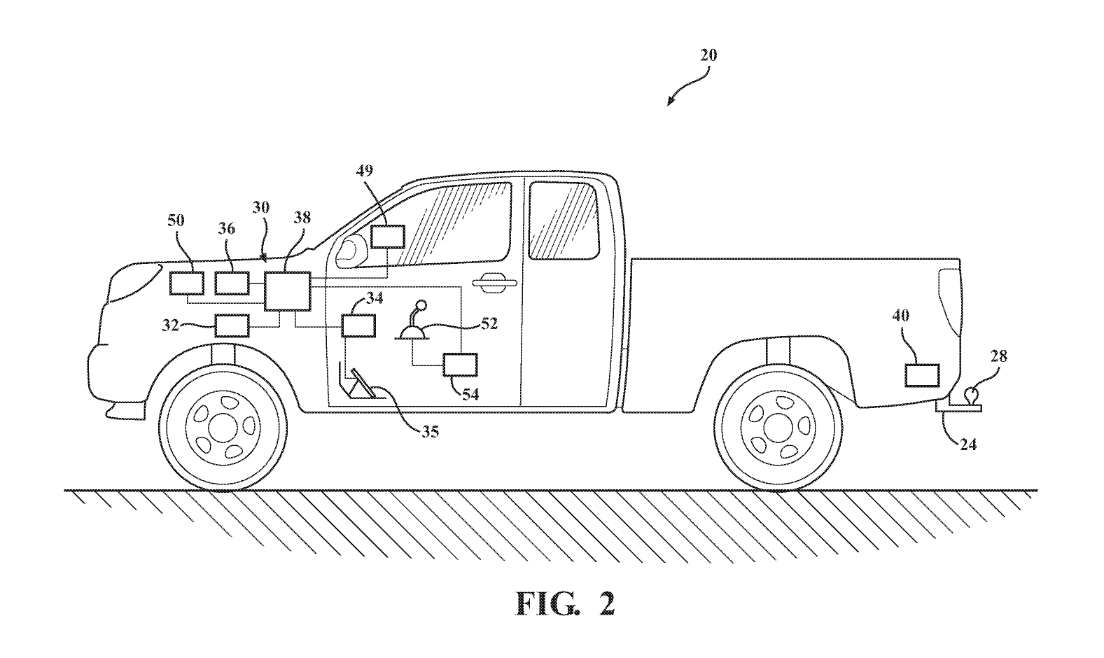

With reference to FIGS. 1 and 2, a vehicle 20 may be configured for towing a trailer 22. The vehicle 20 is illustrated in the drawing figures as a pickup truck, but may have a different configuration, such as, for example, a sport utility vehicle (SUV). The vehicle 20 may include a trailer hitch 24 for attaching the trailer 22 to the vehicle 20. The trailer hitch 24 may be suitably attached to a portion of the vehicle 20, such as a frame. The trailer 22 may be attached to the vehicle 20 by connecting a tongue 26 of the trailer to a ball 28 on the trailer hitch 24. The trailer 22 may have various configurations.

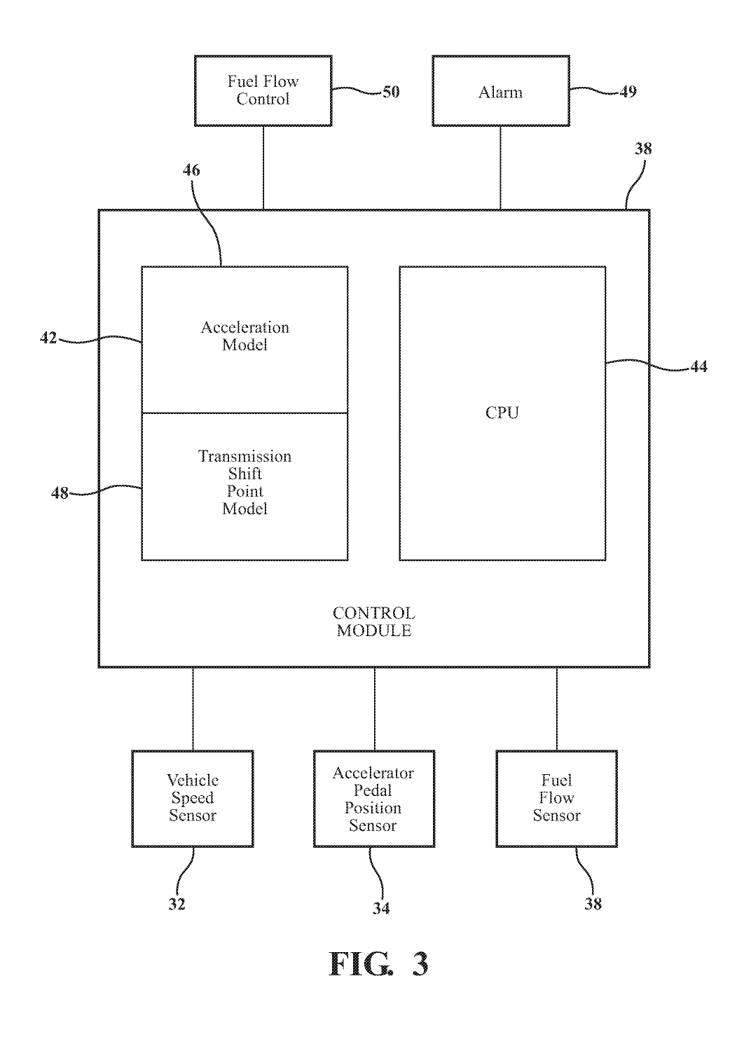

With reference to FIGS. 2 and 3, the vehicle 20 may include a trailer load limit protection system 30 configured to activate various protective measures designed to help prevent damage to the vehicle 20 and minimize disruption of vehicle dynamics in the event a vehicle operator attempts to tow a trailer that exceeds a maximum allowable trailer weight for the vehicle 20. Vehicle dynamics describes how a vehicle responds to forces imposed on the vehicle when in motion. These forces may include steering, cornering, braking and acceleration forces, as well as forces due to external factors, such as wind and road grade (i.e., slope and pitch). The trailer load limit protection system 30 may be used with any type of vehicle, including but not limited to traditional vehicles, electric vehicles, passenger vehicles, sports utility vehicles (SUVs), cross-over vehicles, trucks, vans, buses, recreational vehicles (RV), as well as others.

FIG. 2 provides a schematic illustration of the trailer load limit protection system 30 installed on the vehicle 20. The trailer load limit protection 30 system may determine an estimated weight of the trailer 22 and, if necessary, initiate various protective measures to prevent damage to the vehicle and/or disruption of vehicle dynamics. The trailer load limit protection system 30 may utilize various vehicle sensors to collect vehicle operational and performance parameters and/or data that may be used to determine a weight of the trailer 22. The vehicle sensors operate to transmit a data signal indicative of a corresponding vehicle operating parameter. These vehicle sensors may include, for example, a vehicle speed sensor 32, an accelerator pedal position sensor 34 for detecting a position of an accelerator pedal 35, and a fuel flow sensor 36. Vehicle operating parameters monitored by the vehicle sensors may include, for example, a vehicle speed and/or acceleration, a position of an accelerator pedal and a fuel flow rate. The trailer load limit protection system 30 may also access vehicle operational and performance parameters, data and information collected or stored in other vehicle systems to be used in whole or part by the trailer load limit protection system 30 when determining a weight of the trailer 22. Any number of different sensors, components, devices, modules and systems may provide data and information to the trailer load limit protection system 30 that may be used to determine a weight of the trailer 22. The sensors 32, 34 and 36 may be directly or indirectly coupled to a control module 38. The sensors 32, 34 and 36 may be integrated within another vehicle component, device, module or system, such as, for example, as part of an engine control module (ECM). Other components may be included in or employed by the trailer load limit protection system 30, as the system is not limited to any particular sensor or sensor arrangement.

The vehicle speed sensor 32 may provide the trailer load limit protection system 30 with readings or other information that may be used by the trailer load limit protection system 30 for determining a weight of the trailer 22. For example, the vehicle speed sensor 32 may generate a speed reading indicative of a vehicle speed and/or an acceleration reading corresponding to a vehicle acceleration. The vehicle speed sensor 32 may be directly or indirectly coupled to the control module 38. The vehicle speed sensor 32 may be part of some other vehicle device, module or system, such as, for example, an engine control module (ECM).

The trailer load limit protection system 30 may employ a trailer sensor 40 that provides the trailer load limit protection system 30 with readings or other information indicating that the trailer 22 is attached to the vehicle 20. The trailer sensor 40 may be configured to generate a signal that may be transmitted to the control module 38 indicating the presence of the trailer 22.

The control module 38 may include any variety of electronic processing devices, memory devices, input/output (I/O) devices, and/or other components, and may perform various control and/or communication related functions. The control module 38 may include a memory device 42 operable for storing various sensor readings, look up tables or other data structures, algorithms used to determine a weight of the trailer 22, as well as other information and software. The memory device 42 may also store pertinent characteristics and background information pertaining to vehicle 20. The control module 38 may include a central processing unit (CPU) 44, such as a microprocessor, that executes instructions for software, firmware, programs, algorithms, scripts, and the like, that may be stored in the memory device 42 and may be used by the trailer load limit protection system 30 when determining a weight of the trailer 22. The control module 38 may be electronically connected to sensors, as well as other vehicle components, devices, modules and systems via various vehicle communication systems and networks and can communicate and interact with them when appropriate.

The control module 38 may employ various schemes for assessing whether the weight of the trailer 22 exceeds the allowable maximum weight limit for the vehicle 20. For example, the control module 38 may include a vehicle acceleration model 46 stored in the memory device 42. The vehicle acceleration model 46 may include expected vehicle acceleration rates for when the vehicle 20 is towing a trailer at the maximum allowable trailer weight limit. The expected vehicle acceleration rates may be correlated to corresponding accelerator pedal 35 positions and/or fuel flow rates. The control module 38 may compare an actual vehicle acceleration to an expected vehicle acceleration when determining if the weight of trailer 22 exceeds the maximum allowable trailer weight limit for the vehicle 20. The “actual vehicle acceleration” corresponds to the acceleration that is actually experienced by the vehicle 20. The “actual vehicle acceleration” may be determined, for example, based on the speed signal transmitted from vehicle speed sensor 32. The “expected vehicle acceleration” corresponds to the acceleration that is expected or anticipated of the vehicle 20 when towing a trailer at the allowable maximum trailer weight limit for the vehicle 20 based on a position of the accelerator pedal 35 and/or fuel flow rate. The control module 38 may determine from the vehicle acceleration model 46 an expected vehicle acceleration based on the accelerator pedal 35 position and/or fuel flow rate. The accelerator pedal position sensor 34 may be used to detect the position of the accelerator pedal 35 and the fuel flow sensor 38 may be used to detect the fuel flow rate. The control module 38 may determine whether a weight of the trailer 22 exceeds the maximum allowable trailer weight for the vehicle 20 by evaluating if the vehicle 20 is under accelerating or over accelerating. This may be accomplished by comparing the actual vehicle acceleration to the expected vehicle acceleration. If the actual vehicle acceleration is less than the expected vehicle acceleration, the control module 38 may determine that the weight of the trailer 22 exceeds the maximum allowable trailer weight limit for the vehicle 20 and the control module 38 may proceed to initiate any of various protective measures to prevent damage to the vehicle 20 and/or a significant reduction in vehicle dynamics. If the actual vehicle acceleration is greater than the expected vehicle acceleration, the control module 38 may determine that the weight of the trailer 22 is less than the maximum allowable trailer weight limit for the vehicle 20 and the control module 38 will not proceed to initiate protective measures.

The control module 38 may also employ a transmission shift point model 48 to access whether the trailer 22 exceeds the maximum allowable trailer weight limit for the vehicle 20. The transmission shift point model 48 may be stored in the memory device 42. The transmission shift point model 38 may include expected transmission shift points for when the vehicle 20 is towing a trailer at the maximum allowable trailer weight for the vehicle 20. The expected transmission shift points may be correlated to corresponding positions of accelerator pedal 35 and/or fuel flow rates. The accelerator pedal position sensor 34 may be used to detect the position of the accelerator pedal 35 and the fuel flow sensor 38 may be used to detect the fuel flow rate. The control module 38 may compare an actual transmission shift point to an expected transmission shift point to determine if the weight of the trailer 22 exceeds the maximum allowable weight limit for the vehicle 20. The “actual transmission shift point” corresponds to the transmission shift point that is actually experienced by the vehicle 20. The “actual transmission shift point” may be determined based in data/information received from a device used to control operation of the vehicle transmission, for example, a transmission control module. The “expected transmission shift point” corresponds to the transmission shift point that is expected or anticipated of the vehicle when towing a trailer at the allowable maximum trailer weight limit for the vehicle 20 based on a position of the accelerator pedal 35 and/or fuel flow rate. The control module 38 may determine from the transmission shift point model 38 the expected transmission shift points based on the accelerator pedal 35 position and/or fuel flow rate. The control module 38 may determine whether the weight of the trailer 22 exceeds the maximum allowable trailer weight limit for the vehicle 20 by evaluating if the actual transmission shift points are occurring sooner or later than expected by comparing the actual transmission shift points to the expected transmission shift points. If the actual transmission shift points are occurring later than the expected transmission shift points, the control module 38 may determine that the weight of the trailer 22 exceeds the maximum allowable trailer weight limit for the vehicle 20 and the control module 38 may proceed to initiate any of various protective measures to prevent damage to the vehicle 20 and/or a significant reduction to vehicle dynamics. If the actual transmission shift points are occurring sooner than the expected transmission shift points, the control module 38 may determine that the weight of the trailer 22 is less than the maximum allowable trailer weight limit for the vehicle 20 and the control module 38 will not proceed to initiate protective measures.

The control module 38 may activate various vehicle protection measures in instances where the trailer load limit protection system 30 determines that the trailer 22 exceeds the maximum allowable trailer weight limit for the vehicle 20. The vehicle protection measures may include transmitting a warning that the trailer exceeds the maximum allowable weight limit, preventing the vehicle 20 from operating above a selected maximum speed and preventing a transmission in the vehicle from being shifted out of a park position and into a drive position.

If the trailer load limit protection system 30 determines that the trailer 22 being towed by the vehicle 20 exceeds the maximum allowable trailer weight limit for the vehicle 20, the control module 38 may transmit a signal for activating an alarm 49 to notify the vehicle operator of the situation. The alarm 49 may utilize various warning schemes, which may include, for example, emitting an audible and/or visual warning. The alarm 49 may also provide haptic feedback that applies forces, vibrations, or motions to a vehicle operator to alert them of the situation. The alarm 49 may be located at various locations within a passenger compartment of the vehicle 20. The alarm 49 may include a single warning device or may include multiple warning devices arranged throughout the passenger compartment.

The vehicle protection measures may include limiting a maximum speed of the vehicle. If the trailer load limit protection system 30 determines that the trailer 22 being towed by the vehicle 20 exceeds the maximum allowable trailer weight limit for the vehicle 20, the control module 38 may initiate a protective measure to prevent the vehicle 20 from being operated above a selected maximum speed, such as, for example, 25 miles/hour (MPH). This may be accomplished in a variety of ways. For example, the control module 38 may directly or indirectly interact with a fuel flow control module 50 to control an amount of fuel being delivered to an engine in the vehicle 20 to limit the maximum speed of the vehicle. The control module 38 may also interact with other vehicle systems that may have control over the vehicle fueling system, and transmit instructions to the other vehicle system to limit the amount of fuel delivered to the vehicle engine as a way of limiting the maximum allowable speed of the vehicle 20 when towing a trailer that exceeds the maximum allowable weight limit for the vehicle. The control module 38 may also interact with any other vehicle system that may be used to control a speed of the vehicle 20. In which case, the control module 38 may transmit an appropriate control signal to the other vehicle system with instructions to limit the maximum allowable vehicle speed below the determined maximum speed.

The trailer load limit protection system 30 may also be configured to prevent the transmission of the vehicle from being shifted out of park and into drive when the trailer load limit protection system 30 determines that a weight of the trailer 22 exceeds the maximum allowable weight limit for the vehicle 20. For example, the vehicle 20 may include a shift lever 52 for controlling a transmission in the vehicle 20. The shift lever 52 may be manually actuated by a vehicle operator for shifting the vehicle transmission between a first position, for example, a park position, and a second position, for example, a drive position. The manually actuated shift lever 52 may include a safety switch 54 that operates to prevent the shift lever 52 from unintentionally being moved from the first position (i.e., park position) to the second position (i.e., drive position). A vehicle operator may manually release the safety switch 54 by depressing a button on the safety switch 54 to enable the vehicle operator to manually move the shift lever 52 from the first position to the second position.

Operation of the safety switch 52 may be directly or indirectly controlled by the control module 38. For example, in instances where the trailer load limit protection system 30 determines that a weight of the trailer 22 exceeds the maximum allowable weight limit for the vehicle 20, the control module 38 may transmit a signal to the safety switch 54, or a system used to control operation of the safety switch 54, with instructions to prevent the safety switch 54 from being actuated and thereby preventing the vehicle operator from moving the shift lever 52 from the first position (i.e., the park position) to the second position (i.e., drive position). This is an example of how the trailer load limit protection system 30 may prevent the vehicle 20 from being driven when towing a trailer 22 that exceeds the allowable maximum trailer weight limit for the vehicle 20. The trailer load limit protection system 30 may also control and/or interact with other vehicle system, such as a transmission control module (TCM), that may be activated to prevent the vehicle transmission from being shifted out park and into drive.

It is intended that the scope of the present methods and apparatuses be defined by the following claims. However, it must be understood that the disclosed systems and methods may be practiced otherwise than is specifically explained and illustrated without departing from its spirit or scope. It should be understood by those skilled in the art that various alternatives to the configurations described herein may be employed in practicing the claims without departing from the spirit and scope as defined in the following claims. The scope of the disclosed systems and methods should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. Furthermore, all terms used in the claims are intended to be given their broadest reasonable constructions and their ordinary meanings as understood by those skilled in the art unless an explicit indication to the contrary is made herein. In particular, use of the singular articles such as “a,” “the,” “said,” etc., should be read to recite one or more of the indicated elements unless a claim recites an explicit limitation to the contrary. It is intended that the following claims define the scope of the device and that the method and apparatus within the scope of these claims and their equivalents be covered thereby. In sum, it should be understood that the device is capable of modification and variation and is limited only by the following claims.

What is claimed is:

1. A method for limiting operation of a vehicle when towing a trailer, the method comprising:
transmitting a speed signal from a speed sensor indicative of a speed of the vehicle;
determining an actual vehicle acceleration of the vehicle while towing the trailer based on the speed signal;
transmitting a data signal from a vehicle sensor indicative of a vehicle operating parameter;
determining an expected vehicle acceleration of the vehicle when towing a trailer having a weight substantially equal to a maximum allowable weight limit for the vehicle based on the vehicle operating parameter;
comparing the actual vehicle acceleration with the expected vehicle acceleration; and
initiating at least one vehicle protection measure for limiting operation of the vehicle when the actual vehicle acceleration is equal to or less than the expected vehicle acceleration.

2. The method of claim 1, wherein the at least one vehicle protection measure comprises at least one of limiting operation of the vehicle to a maximum allowable vehicle speed, limiting a fuel flow rate to an engine of the vehicle and preventing a transmission on the vehicle from being shifted from a first shift position to a second shift position.

3. The method of claim 1, wherein the first shift position corresponds to a park position and the second shift position corresponds to a drive position.

4. The method of claim 1, wherein the vehicle operating parameter corresponds to at least one of an accelerator pedal position and a fuel flow rate, the method further comprising employing a vehicle acceleration model for determining the expected vehicle acceleration, wherein the vehicle acceleration model correlates an expected vehicle acceleration with at least one of the accelerator pedal position and fuel flow rate.

5. A method for limiting operation of a vehicle when towing a trailer, the method comprising:
detecting an actual transmission shift point of a transmission on the vehicle while the vehicle is towing the trailer;
transmitting a data signal from a vehicle sensor indicative of a vehicle operating parameter;
determining an expected transmission shift point of the transmission when towing a trailer having a weight substantially equal to a maximum allowable weight limit for the vehicle based on the vehicle operating parameter;
comparing the actual transmission shift point with the expected transmission shift point; and
initiating at least one vehicle protection measure for limiting operation of the vehicle when the actual transmission shift point occurs after the expected transmission shift point.

6. The method of claim 5, wherein the at least one vehicle protection measure comprises at least one of limiting operation of the vehicle to a maximum allowable vehicle speed, limiting a fuel flow rate to an engine of the vehicle and preventing a transmission on the vehicle from being shifted from a first shift position to a second shift position.

7. The method of claim 5, wherein the first shift position corresponds to a park position and the second shift position corresponds to a drive position.

8. The method of claim 5, wherein the vehicle parameter comprises at least one of an accelerator pedal position and a fuel flow rate, the method further comprising employing a transmission shift point model for determining the expected transmission shift point, wherein the transmission shift point model correlates an expected transmission shift point with at least one of the accelerator pedal position and fuel flow rate.

9. A trailer hauling load limit protection apparatus comprising:
at least one or more computing devices configured for communication with at least one vehicle sensor, the at least one or more computing devices comprising:
one or more processors for controlling operation of the one or more computing devices;
one or more memory for storing data and program instructions used by the one or more processors, wherein the one or more processors are configured to execute instructions stored in the memory to:
determine an actual vehicle acceleration based on a first signal received from the at least one vehicle sensor;
determine an expected vehicle acceleration of the vehicle when towing a trailer having a weight substantially equal to a maximum allowable weight limit for the vehicle based on a second signal received from the at least one vehicle sensor;
compare the actual vehicle acceleration to the expected vehicle acceleration; and
transmit a command to a vehicle system to implement at least one vehicle protection measure for limiting operation of the vehicle when the actual vehicle acceleration is equal to or less than the expected vehicle acceleration.

10. The trailer hauling load limit protection apparatus of claim 9 further comprising the at least one vehicle sensor.

11. The trailer hauling load limit protection apparatus of claim 10, wherein the at least one vehicle sensor comprises at least one of a speed sensor, an accelerator pedal position sensor and a fuel flow sensor.

12. The trailer hauling load limit protection apparatus of claim 9, wherein the expected vehicle acceleration is determined based on a vehicle acceleration model stored in the memory.

13. The trailer hauling load limit protection apparatus of claim 9, wherein the first signal is a speed signal indicative of a speed of the vehicle.

14. The trailer hauling load limit protection apparatus of claim 9, wherein the second signal is indicative of at least one of an accelerator pedal position and a fuel flow rate.

15. The trailer hauling load limit protection apparatus of claim 9, wherein the at least one vehicle protection measure comprises at least one of limiting operation of the vehicle to a maximum allowable vehicle speed, limiting a fuel flow rate to an engine of the vehicle and preventing a transmission on the vehicle from being shifted from a first shift position to a second shift position.

16. A trailer hauling load limit protection apparatus comprising:
at least one or more computing devices configured for communication with at least one vehicle sensor, the at least one or more computing devices comprising:
one or more processors for controlling operation of the one or more computing devices;
one or more memory for storing data and program instructions used by the one or more processors, wherein the one or more processors are configured to execute instructions stored in the memory to:
determine an expected transmission shift point of the vehicle when towing a trailer having a weight substantially equal to a maximum allowable weight limit for the vehicle based on a data signal received from the at least one vehicle sensor;
compare an actual transmission shift point with the expected transmission shift point; and
transmit a command to a vehicle system to implement at least one vehicle protection measure for limiting operation of the vehicle when the actual transmission shift point occurs after the expected transmission shift point.

17. The trailer hauling load limit protection apparatus of claim 16 further comprising the at least one vehicle sensor.

18. The trailer hauling load limit protection apparatus of claim 17, wherein the at least one vehicle sensor comprises at least one of a speed sensor, an accelerator pedal position sensor and a fuel flow sensor.

19. The trailer hauling load limit protection apparatus of claim 16, wherein the expected transmission shift point is determined based on a transmission shift point model stored in the memory.

20. The trailer hauling load limit protection apparatus of claim 16, wherein the data signal is indicative of at least one of an accelerator pedal position and a fuel flow rate.

21. The trailer hauling load limit protection apparatus of claim 16, wherein the at least one vehicle protection measure comprises at least one of limiting operation of the vehicle to a maximum allowable vehicle speed, limiting a fuel flow rate to an engine of the vehicle and preventing a transmission on the vehicle from being shifted from a first shift position to a second shift position.
